(19) United States
(12) Patent Application Publication
(10) Pub. No.: US 2008/0189479 A1
(43) Pub. Date: Aug. 7, 2008

(54) Device, system and method for controlling memory operations

(75) Inventors: Bryan Cope, Austin, TX (US); Tauseef Rab, Austin, TX (US); David Cureton Baker, Austin, TX (US)

Correspondence Address: TOLER LAW GROUP, 8500 BLUFFSTONE COVE, SUITE A201, AUSTIN, TX, 78759, US

(73) Assignee: SIGMATEL, INC., Austin, TX (US)

(21) Appl. No.: 11/701,628

(22) Filed: Feb. 2, 2007

(51) Int. Cl. G06F 13/00; G06F 13/36; G06F 12/00

(52) U.S. Cl. 711/104; 710/111; 710/306; 711/E12.001

(57) ABSTRACT

A device, system and method for controlling memory operations are disclosed. In an embodiment, data is received at one of multiple slave devices in an integrated circuit. The data is received from at least one bus in a multiple layer bus and is provided to a memory controller. The data is stored in a selected one of multiple memory banks. The memory banks are interleaved such that a first memory address resides on a first memory bank and a next memory address resides on a second memory bank.

### FIELD OF THE DISCLOSURE

The present disclosure is generally related to devices, systems and methods of controlling memory operations.

### BACKGROUND

Multiple memory devices can be used in an electronic system. A system processor can provide instructions to multiple memory controllers to operate each memory device. However, dedicating processor resources to coordinate multiple memory controllers can impede system performance. Hence, there is a need for an improved device, system and method for controlling memory operations.

### BRIEF DESCRIPTION OF THE DRAWINGS

FIG. 1 is a block diagram of a particular illustrative embodiment of a device to control memory operations;

FIG. 2 is a block diagram of a particular illustrative embodiment of a system to control memory operations;

FIG. 3 is a block diagram of another illustrative embodiment of a system to control memory operations;

FIG. 4 is a diagram of a particular illustrative embodiment of operational states of a device to control memory operations; and

FIG. 5 is a flow chart depicting a particular illustrative embodiment of a method of controlling memory operations.

### DETAILED DESCRIPTION OF THE DRAWINGS

In a particular embodiment, a device to control memory operations is disclosed. The device includes a memory controller and a first data bus of a multi-layer data bus coupled to the memory controller. The device also includes a second data bus of the multi-layer data bus coupled to the memory controller. The device includes a first memory slave coupled to the first data bus and the memory controller. The device also includes a second memory slave coupled to the second data bus and the memory controller. The device includes a first memory bank coupled to a first data output of the memory controller and a second memory bank coupled to a second data output of the memory controller. The first memory bank and the second memory bank are interleaved.

In another embodiment, an integrated circuit to control memory operations is disclosed. The integrated circuit includes a first data bus and a second data bus. The integrated circuit includes a memory controller coupled to the first data bus and the second data bus. The integrated circuit also includes a first memory bank coupled to the memory controller and a second memory bank coupled to the memory controller. The logic includes logic to allow a first data operation from the first data bus to be performed at one of the first memory bank and the second memory bank and to simultaneously allow a second data operation from the second data bus to be performed at the other of the first memory bank and the second memory bank. The first memory bank and the second memory bank are interleaved such that consecutive memory addresses reside on different memory banks.

In another embodiment, a method of controlling memory operations is disclosed. The method includes receiving data at one of multiple slave devices in an integrated circuit. The data is received from at least one bus in a multiple layer bus. The method includes providing the data to a memory controller. The method also includes selecting one of multiple memory banks as a selected memory bank to store the data. The memory banks are interleaved such that a first memory address resides on a first memory bank and a next memory address resides on a second memory bank. The method further includes storing the data in the selected memory bank.

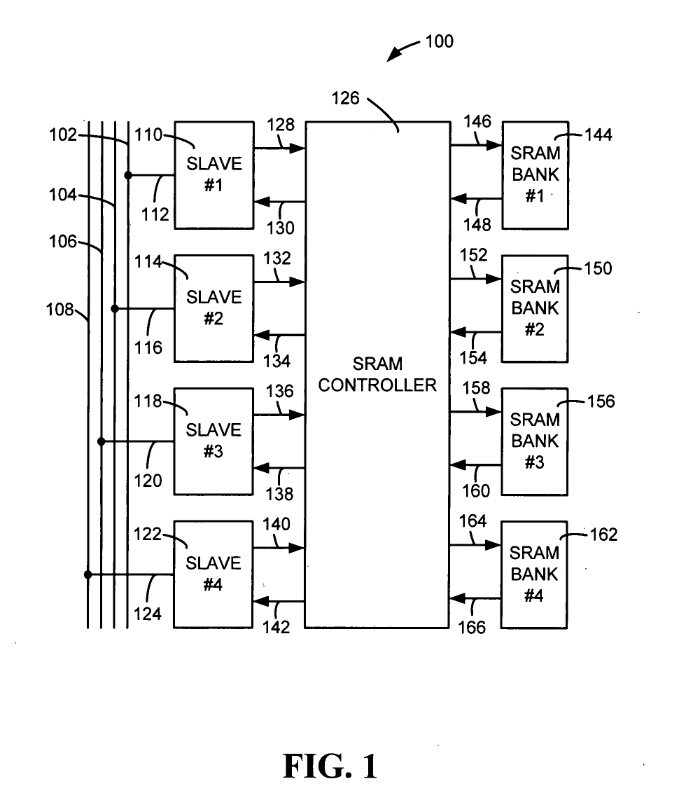

Referring to FIG. 1, a particular illustrative embodiment of a system to control memory operations is depicted and generally designated 100. The system 100 includes a multi-layer Advanced High-Speed Bus (AHB) that has a first AHB layer bus 102, a second AHB layer bus 104, a third AHB layer bus 106 and a fourth AHB layer bus 108. A first slave device 110 is coupled to the first AHB layer bus 102 via a first data path 112. A second slave device 114 is coupled to the second AHB layer bus 104 via a second data path 116. A third slave device 118 is coupled to the third AHB layer bus 106 via a third data path 120, and a fourth slave device 122 is coupled to the fourth AHB layer bus 108 via a fourth data path 124.

Each slave device 110, 114, 118, and 122 is coupled to a memory controller 126. The memory controller 126 is further coupled to a first memory bank 144, a second memory bank 150, a third memory bank 156, and a fourth memory bank 162. The memory banks 144, 150, 156, and 162 are interleaved so that consecutive memory addresses reside on different memory banks. In a particular embodiment, the memory controller 126 is a Static Random-Access Memory (SRAM) controller, and the memory banks 144, 150, 156, and 162 are SRAM banks.

During operation, the memory controller 126 may simultaneously couple more than one of the slave devices 110, 114, 118, and 122 to a separate memory bank 144, 150, 156, or 162 to allow simultaneous memory operations to be performed.

In a particular embodiment, the first slave device 110 may receive memory operation instructions and data from the first AHB layer bus 102 via the first communication path 112. The first slave device 110 may provide a memory address associated with the memory operation to the memory controller 126 via a first slave signal output 128.

The memory controller 126 may receive the memory address from the first slave device 110 and may determine which of the memory banks 144, 150, 156, and 162 corresponds to the memory address. The memory controller 126 can couple the first slave device 110 to the memory bank 144, 150, 156, or 162 that corresponds to the memory address so that the memory operation may be performed via the first slave device 110.

In a specific embodiment, the first slave device 110 may receive a data write instruction and a memory address from the first AHB layer bus 102. The first slave device 110 may provide the memory address to the memory controller 126. The memory controller 126 may select a memory bank 144, 150, 156, or 162 that corresponds to the memory address and may couple the first slave device to the selected memory bank 144, 150, 156, or 162. The first slave device 110 may write data to the selected memory bank 144, 150, 156, or 162 via a memory signal input 146, 152, 158, or 164. In another specific embodiment, the first slave device may receive data read from the selected memory bank 144, 150, 156, or 162 via a memory signal output 148, 154, 160, or 166 and a first slave signal input 130.

Similarly, one or more of the other slave devices 114, 118, and 122 may receive memory operation instructions and a memory address via the respective AHB layer bus 104, 106, or 108. The slave device 114, 118, and 122 may send the memory controller 126 the received memory address via a respective slave output 132, 136, or 140. The memory controller 126 may couple the slave device 114, 118, or 122 to the memory bank 144, 150, 156, or 162 that corresponds to the memory address. The slave device 114, 118, or 122 may send data to the selected memory bank 144, 150, 156, or 162 via the respective memory signal input 146, 152, 158, or 164. Likewise, the slave device 114, 118, or 122 may receive data from the selected memory bank 144, 150, 156, or 162 via the respective memory signal output 148, 154, 160, or 166 and a respective slave signal input 134, 138, or 142.

If two or more slave devices 110, 114, 118, and 122 simultaneously request memory operations at a single selected memory bank 144, 150, 156, or 162, the memory controller 126 may perform a round robin calculation to determine which slave device 110, 114, 118, or 122 is granted first access to the selected memory bank 144, 150, 156, or 162. The memory controller 126 can stall the other slave devices 110, 114, 118, and 122 requesting access to the selected memory bank 144, 150, 156, or 162 until each slave device 110, 114, 118, and 122 receives access during subsequent round robin calculations.

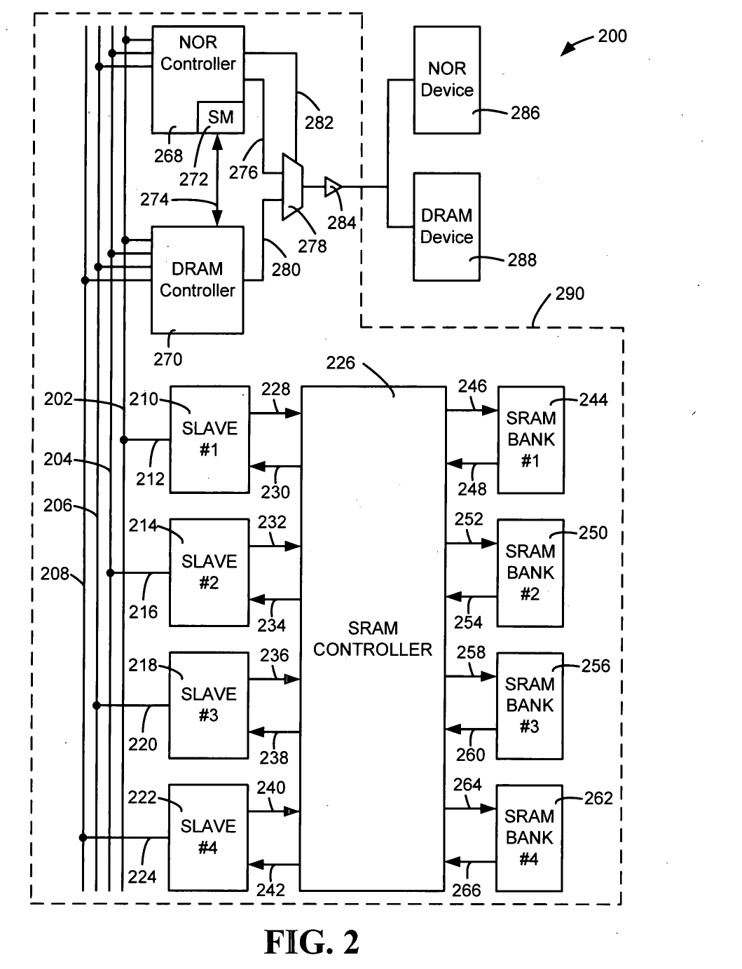

Referring to FIG. 2, a particular illustrative embodiment of a system to control memory operations is depicted and generally designated 200. The system 200 includes a multi-layer Advanced High-Speed Bus (AHB) that has a first AHB layer bus 202, a second AHB layer bus 204, a third AHB layer bus 206 and a fourth AHB layer bus 208. A first slave device 210 is coupled to the first AHB layer bus 202 via a first data path 212. A second slave device 214 is coupled to the second AHB layer bus 204 via a second data path 216. A third slave device 218 is coupled to the third AHB layer bus 206 via a third data path 220, and a fourth slave device 222 is coupled to the fourth AHB layer bus 208 via a fourth data path 224.

Each slave device 210, 214, 218 and 222 is coupled to a memory controller 226. The memory controller 226 is further coupled to a first memory bank 244, a second memory bank 250, a third memory bank 256, and a fourth memory bank 262. The memory banks 244, 250, 256, and 262 are interleaved so that consecutive memory addresses reside on different memory banks. In a particular embodiment, the memory banks 244, 250, 256, and 262 may include on-chip Random Access Memory (RAM). In a particular embodiment, the memory controller 226 may be a Static Random-Access Memory (SRAM) controller, and the memory banks 244, 250, 256, and 262 may be SRAM banks.

A flash memory controller 268 is coupled to each of the first AHB layer bus 202, the second AHB layer bus 204, and the third AHB layer bus 206. A Dynamic Random Access Memory (DRAM) controller 270 is coupled to each of the AHB layer busses 202, 204, 206, and 208. In a particular embodiment, the flash memory controller 268 may include logic 272 that operates as a state machine to exchange handshaking signals with the DRAM controller 270 via a communication path 274.

The flash memory controller 268 is coupled to an input of a multiplexer 278 via a flash data path 276. The DRAM controller is coupled to another input of the multiplexer 278 via a DRAM data path 280. An output of the multiplexer 278 is coupled to a flash memory device 286 and further coupled to a DRAM device 288 via a shared output pin 284. In a particular embodiment, the output pin 284 may be a data output pin of an integrated circuit 290 that includes all of the system 100 except the flash memory device 286 and the DRAM device 288. In a specific embodiment, the flash controller 268 may be a Not-OR (NOR) flash controller and the flash memory device 286 may be a NOR flash device.

During operation, the memory controller 226 can simultaneously couple each of the slave devices 210, 214, 218, and 222 to a separate memory bank 244, 250, 256, or 262 to allow simultaneous memory operations to be performed. Each of the slave devices 210, 214, 218, and 222 may receive a separate memory operation instruction, data, and a memory address via the respective AHB layer bus 202, 204, 206, or 208. Each slave device 210, 214, 218, and 222 may send the memory controller 226 the data and memory address via a respective slave output 228, 232, 236, or 240. The memory controller 226 may couple the slave device 210, 214, 218, or 222 to the memory bank 244, 250, 256, or 262 that corresponds to the memory address. The slave device 210, 214, 218, or 222 may then send data to the selected memory bank 244, 250, 256, or 262 via a respective memory signal input 246, 252, 258, or 264. Likewise, the slave device 210, 214, 218, or 222 may receive data from the selected memory bank 244, 250, 256, or 262 via a respective memory output 248, 254, 260, or 266 and a respective slave signal input 230, 234, 238, or 242.

If two or more slave devices 210, 214, 218, and 222 simultaneously request memory operations at a single selected memory bank 244, 250, 256, or 262, the memory controller 226 may perform a round robin calculation to determine which slave device 210, 214, 218, or 222 is granted first access to the selected memory bank 244, 250, 256, or 262. The memory controller 226 may stall the other slave devices 210, 214, 218, and 222 requesting access to the selected memory bank 244, 250, 256, or 262 until each slave device 210, 214, 218, and 222 receives access during subsequent round robin calculations.

In addition, requests or instructions for memory operations may be received at the flash controller 268 and at the DRAM controller 270 via the AHB. The multiplexer 278 can dynamically select between data received via the flash data path 276 and data received via the DRAM data path 280. In a particular embodiment, the multiplexer 278 may select the DRAM data path 280 by default so that the DRAM controller 270 controls the output pin 284.

When the flash controller 268 receives a memory operation instruction or request from an AHB layer bus 202, 204, or 206, the logic 272 may send a pin request signal to the DRAM controller 270 via the communication path 274. In a particular embodiment, the pin request signal may cause the DRAM controller 270 to instruct the DRAM device 288 to switch to operation at a reduced clock frequency. In a particular embodiment, the pin request signal may cause the DRAM controller 270 to instruct the DRAM device 288 to enter a self-refresh mode to preserve data integrity. The DRAM controller 270 may send a pin grant signal to the flash controller 268 via the communication path 274.

Upon receiving the pin grant signal, the logic 272 may send a control signal output 282 that causes the multiplexer 278 to select the flash data path 276 so that the flash controller 268 controls the shared output pin 284. The flash controller 268 may then perform memory operations at the flash memory device 286. When the flash memory operations are completed, the flash controller 268 may send a control signal output 282 that causes the multiplexer 278 to select the DRAM data path 280. The flash controller 268 may send a pin request stop signal to the DRAM controller 270 indicating that the shared output pin 284 is no longer requested by the flash controller 268.

The DRAM controller 270 may respond to the pin request stop signal by sending a pin grant stop signal to the flash controller 268. In a particular embodiment, the DRAM controller 270 may instruct the DRAM device 288 to return to operation at the original clock frequency. In a particular embodiment, the DRAM controller 270 may instruct the DRAM device 288 to exit the self-refresh mode. The DRAM controller 270 may resume memory operations at the DRAM device 288.

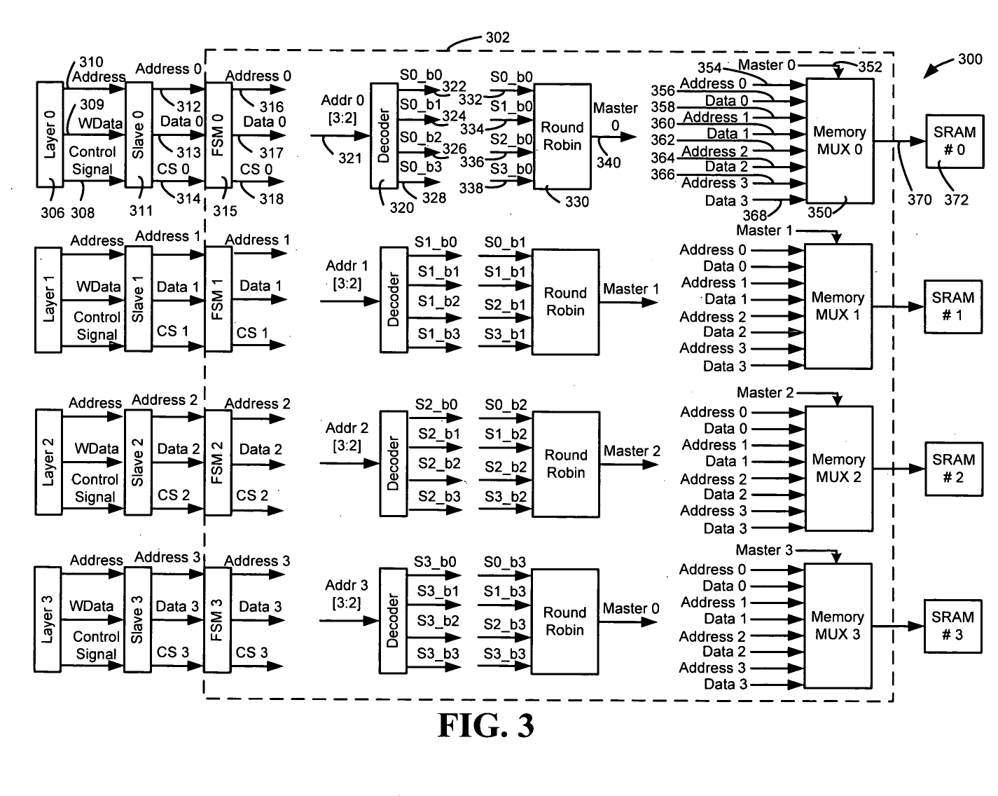

Referring to FIG. 3, a particular illustrative embodiment of a system to control memory operations is depicted and generally designated 300. The system 300 includes a memory controller 302 that receives memory operation requests from multiple busses and can enable simultaneous access to multiple memory banks. A representative bus 306 is coupled to a representative slave device 311. In a particular embodiment, the bus 306 is an Advanced High-Speed Bus (AHB) layer bus of a multi-layer AHB. The slave device 311 is coupled to a representative finite state machine (FSM) 315 of the memory controller 302. In a particular embodiment, the memory controller 302 is a Static Random-Access Memory (SRAM) controller.

The memory controller 302 includes multiple decoders, including a representative decoder 320 that is coupled to the FSM 315. The memory controller 302 includes multiple round robin modules, including a representative round robin module 330, that are coupled to the decoders. The memory controller 302 also includes multiple memory multiplexers, including a representative memory multiplexer (MUX) 350 that is coupled to the round robin module 330. The MUX 350 is also coupled to multiple finite state machines of the memory controller 302, including the FSM 315. Outputs of the MUX 350 are coupled to a representative memory bank 372. In a particular embodiment, the memory bank 372 is a SRAM bank. In a particular embodiment, the memory controller 302 has a number of finite state machines, decoders, multiplexers, and memory banks that is equal to the number of bus layers.

During operation, the slave device 311 may receive data for a memory operation request, including a control signal input 308, a data input (WData) 309, and an address data input 310. The slave device 311 may cache the received data and provide an address signal 312, a data signal 313, and a control signal (CS) 314 to the FSM 315.

The FSM 315 receives the address signal 312, the data signal 313, and the control signal 314 from the slave device 311. In addition, the FSM 315 may receive a grant signal from a round robin module that indicates that the slave was granted permission to access a memory bank. Based on a state of the FSM 315 and the received input signals, the FSM 315 may determine an address output 316, a data output 317, and a control signal output 318.

The decoder 320 receives the address output 316 and determines which memory bank corresponds to the address. The decoder 320 generates bank selection signal outputs 322, 324, 326, and 328 that indicate which memory bank is requested by the slave device 311. In a particular embodiment, an S0_b0 high signal can indicate that the slave device 311 requests access to the memory bank 372.

The round robin module 330 receives the bank selection signal 322 from the decoder 320. In addition, the round robin module 330 may receive bank selection signals from other decoders of the memory controller 302 that request access to the memory bank 372. The round robin module 330 includes logic to perform a round robin calculation to schedule access to the memory bank 372 when more than one slave devices request access to the memory bank 372. The round robin module 330 generates a master output signal 340 that is received at a master input 352 of the MUX 350. The master output 340 may determine which slave device is granted access to the memory bank 372. The round robin module 330 may also provide a grant signal to the finite state machines that indicates which slave device is granted access to the memory bank 372.

In a specific embodiment, the round robin module 330 may perform a round robin calculation that uses a counter to determine a sequence of slave devices that are granted access to the memory bank 372. In a specific embodiment, the memory controller 302 may be coupled to four slave devices S0, S1, S2, and S3. A first counter value may determine that access to the memory bank 372 is granted first to S0, next to S1, next to S2, and last to S3. If a slave device S0, S1, S2, or S3 does not request access to the memory bank 372, the slave device may be skipped and access granted to the next slave device. A second counter value may determine access in the order: S1, S2, S3, S0. A third counter value may determine access in the order: S2, S3, S0, S1. A fourth counter value may determine access in the order: S3, S0, S1, S2. The counter may return to the first counter value after all requested memory operations at the fourth counter value have been completed. The round robin module 330 may pause the counter if no slave device requests access to the memory bank 372. The round robin module 330 may restart the counter at its paused state when a new request for access to the memory bank 372 is received.

The MUX 350 may use the master signal 340 from the round robin module 330 to select an address and data input. In a specific embodiment, the MUX 350 may select an address input 354 and a data input 356 corresponding to the slave device 306, an address input 358 and a data input 360 corresponding to a second slave device, an address input 362 and a data input 364 corresponding to a third slave device, or an address input 366 and a data input 368 corresponding to a fourth slave device. The selected slave device can perform memory operations at the data bank 372 via a data path 370.

In a particular embodiment, the memory device 302 may contain multiple finite state machines, decoders, round robin modules, and multiplexers that operate in substantially the same way as the representative components discussed above. The multiple finite state machines, decoders, round robin modules, and multiplexers may be interconnected so that each layer bus may access any of the memory banks via substantially the same process as described for the representative bus 306 accessing the representative memory bank 372. In a particular embodiment, the number of finite state machines, decoders, round robin modules, and multiplexers is proportional to a number of bus layers in a multi-layer bus. In another particular embodiment, such as shown in FIG. 3, the memory controller 302 includes four finite state machines, each coupled to a layer of a multi-layer bus. In addition, the memory controller includes four decoders, four round robin modules, and four multiplexers, each multiplexer connected to a memory bank.

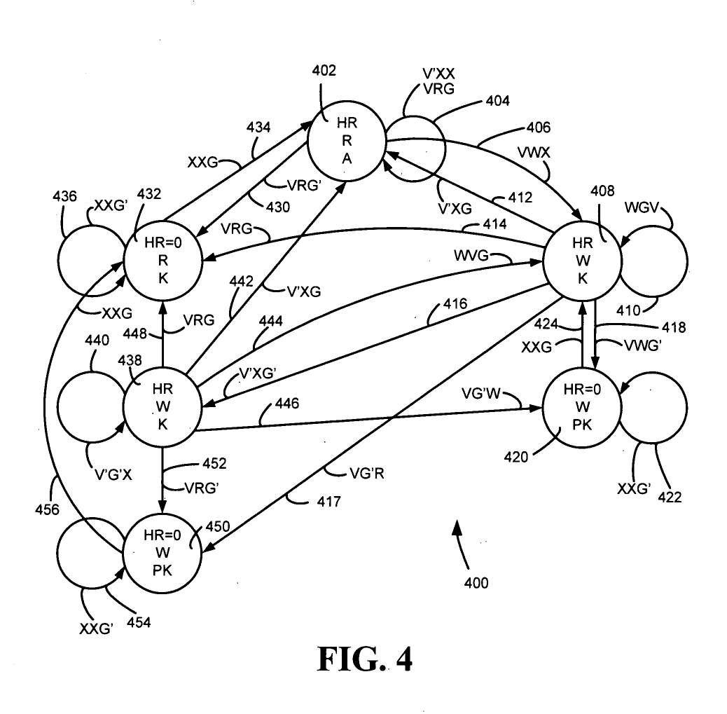

Referring to FIG. 4, a particular illustrative embodiment of operational states of a device to control memory operations is depicted and generally designated 400. The operational states 400 include a first state 402, a second state 408, a third state 420, a fourth state 432, a fifth state 438, and a sixth state 450. At each state 400, 402, 408, 420, 432, 438, and 450, the device outputs an address, a read or write signal, and a ready or not-ready signal. Operation transitions between the states 400, 402, 408, 432, 438, and 450 based on a received valid or not-valid signal input, a received read or write signal input, and a received grant or not-grant signal input. In a particular embodiment, the state diagram 400 depicts an operation of the FSM 315.

In the first state 402, a ready signal (HR), a read signal (R), and an address (A) signal are output. In a particular embodiment, the HR signal may indicate to a bus master that a memory bank is ready for data operations. In a particular embodiment, the R signal and the A signal may indicate to a memory bank a data read operation is requested at the memory address A.

At transition 404, when a not-valid input (V′) is received, operation continues at the first state 402. In a particular embodiment, the not valid signal may indicate that a bus master is not requesting access to a memory address.

In addition, at transition 404, when a valid input (V), a read input (R), and a grant input (G) are received, operation continues at the first state 402. In a particular embodiment, the valid input may indicate that a bus master is requesting access to a memory address. The grant input may indicate that access to the memory address has been granted. The read input may indicate that a next memory operation will be a data read operation.

Operation transitions from the first state 402 to the second state 408 when the valid input (V) and a write input (W) are received at transition 406. In a particular embodiment, the write input may indicate that a next memory operation will be a data write operation. At the second state 408, the ready signal, a write signal (W), and a second address (K) are output. In a particular embodiment, the write signal (W) may indicate that a data write operation is requested at the memory address K. In a specific embodiment, the address K can be a bus master's keeper's address.

Operation continues at the second state 408 as long as the valid input, the write input, and the grant input continue to be received, at transition 410. If the not-valid input and the grant input are received, operation returns to the first state 402 at transition 412. If the not-valid input and the not-grant input are received, operation proceeds to the fifth state 438. If the valid input, the write input, and the non-grant input are received, operation proceeds to the third state 420 at transition 418.

At the third state 420, a not-ready signal (HR=0), a third address output (PK), and the write signal are output. In a particular embodiment, the third address output may be a bus master's previous keeper's address. In a particular embodiment, the third state 420 can represent a state where a previous request for a memory write operation has not been granted.

Operation continues at the third state 422 while the non-grant input is received, at transition 422. When the grant signal is received, operation returns to the second state 408 at transition 424.

From the second state 408, operation proceeds to the fourth state 432 when the valid input, the grant input, and the read input are received at transition 414. Operation may also proceed to the fourth state 432 from the first state 402 when the valid input, the read input, and the non-grant input are received at transition 430.

At the fourth state 432, the not ready signal, the read signal, and the second address are output. In a particular embodiment, the fourth state 432 may represent a state where a read request has been made but not yet granted. Operation continues at the fourth state 432 as long as the not-grant input is received, at transition 436. When the grant input is received at the fourth state, operation returns to the first state 402, at transition 434.

At the fifth state 438, the ready signal, the write signal, and the second address are output. The fifth state 438 is only entered from the second state 408 when the not-valid and the not-grant inputs are received at transition 416. In a particular embodiment, the fifth state 438 may represent a state where a memory write request is received from a bus but interrupted before the memory write access is granted. Operation continues in the fifth state 438 as long both the not-valid input and the not-grant input are received, at transition 440.

From the fifth state 438, if the grant input is received but not the valid input, operation returns to the first state 402 at transition 442. If the valid input and the grant input are received, processing proceeds to the second state 408, in response to the write input at transition 444, or to the fourth state 432, in response to the read input at transition 448. If the valid input is received without the grant input, processing proceeds to the third state 420, in response to the write input at transition 446, or to the sixth state 450, in response to the read input at transition 452. Operation can also proceed to the sixth state 450 from the second state 408 when the valid signal, the non-grant signal, and the read signal are received at transition 417.

At the sixth state 450, the not-ready signal, the write signal, and the third address are output. In a particular embodiment, the sixth state 450 can represent a state where connection with a bus master is lost before a memory write request is completed, the connection is reestablished before access to the memory is granted, and a memory read request is received.

Operation continues at the sixth state 450 as long as the not-grant input is received, at transition 454. When the grant input is received, operation proceeds to the fourth state 432, at transition 456.

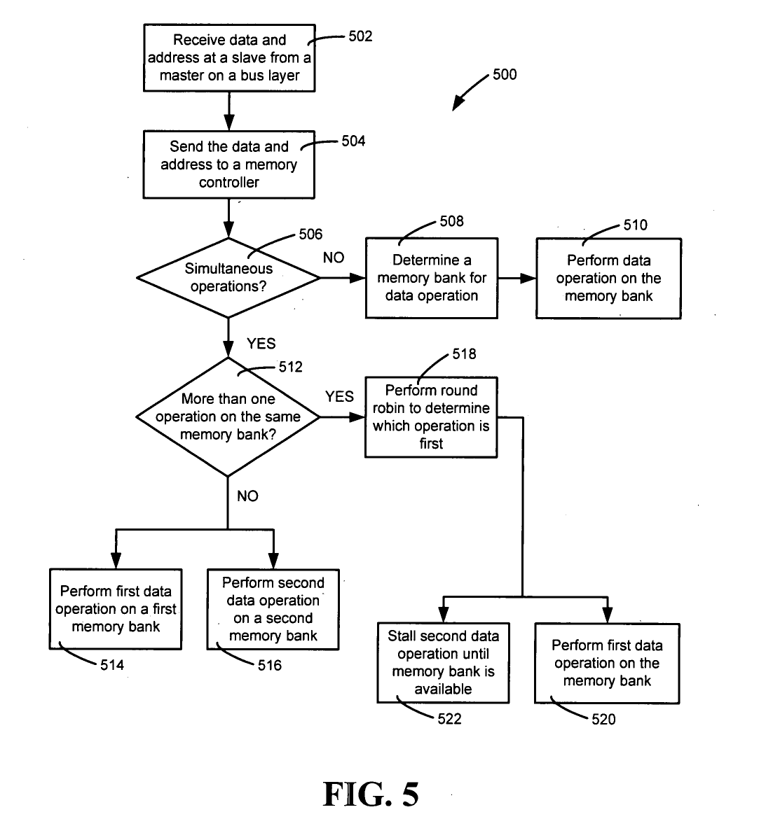

Referring to FIG. 5, a particular illustrative embodiment of a method of controlling memory operations is depicted and generally designated 500. A memory address and data may be received at one of multiple slave devices in an integrated circuit, at 502. The data and memory address are received from at least one bus in a multiple layer bus, such as a multi-layer Advanced High-Speed Bus (AHB). The data and memory address may indicate a data operation, such as a memory read or write, that is designated by a master on the bus layer.

The data and memory are provided to a memory controller, at 504. In a particular embodiment, the memory controller may control multiple memory banks that are interleaved such that a first memory address resides on a first memory bank and a next memory address resides on a second memory bank. In a specific embodiment, the memory controller may be a Static Random-Access Memory (SRAM) controller and the memory banks may be SRAM banks.

The memory controller determines if multiple simultaneous data operations are indicated, at 506. In a particular embodiment, data and memory addresses may be received for simultaneous data operations via more than one bus layer. If multiple simultaneous data operations are not indicated, a memory bank is determined for the data operation, at 508. The data operation is then performed at the determined memory bank, at 510. In a particular embodiment, the data operation may be a memory write operation, and the received data may be written at the memory address. In another particular embodiment, the data operation may be a memory read operation, and data may be read from the memory address.

In a particular embodiment, if multiple simultaneous data operations are indicated, the memory controller may determine if more than one data operation is addressed at the same memory bank, at 512. If each data operation addresses memory at a separate memory bank, the data operations may be performed simultaneously. In a particular embodiment, a first data operation may be performed by a first bus on a first memory bank, at 514. A second data operation may be simultaneously performed by a second bus on a second memory bank, at 516.

In a particular embodiment, if more than one data operation addresses memory at the same memory bank, the memory controller may determine which data operation is first by performing a round robin scheme, at 518.

In a particular embodiment, point arbitration may be performed to grant control of the memory bank to a first data bus based on the calculated order of operations so that a first data operation is performed at the memory bank, at 520. A second data bus may be stalled from performing the second data operation while the first data bus is performing the first data operation. The second data operation may be stalled until the memory bank is available, such as after the first data operation has been completed, at 522.

While specific systems and components of systems have been shown, it should be understood that many alternatives are available for such systems and components. In a particular illustrative embodiment, for example, a system to control memory operations may include hardware, software, firmware, or any combination thereof to perform functions and methods of operation as described. It should be understood that particular embodiments may be practiced solely by a processor executing processor instructions and accessing a processor readable memory, or in combination with hardware, firmware, software, or any combination thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An integrated circuit comprising:
a first data bus;
a second data bus;
a memory controller coupled to the first data bus and the second data bus;
a first memory bank coupled to the memory controller;
a second memory bank coupled to the memory controller;
wherein the memory controller further comprises logic to allow a first data operation from the first data bus to be performed at one of the first memory bank and the second memory bank and to simultaneously allow a second data operation from the second data bus to be performed at the other of the first memory bank and the second memory bank; and
wherein the first memory bank and the second memory bank are interleaved such that consecutive memory addresses reside on different memory banks.

2. The integrated circuit of claim 1 wherein the logic further comprises logic to perform a round robin calculation to determine which data bus to allow to perform a data operation on a specific memory bank.

3. The integrated circuit of claim 2 wherein the round robin calculation manages operations when more than one data bus attempts to simultaneously perform data operations on the specific memory bank.

4. The integrated circuit of claim 3 wherein the logic to perform the round robin calculation determines that the first data bus may perform a first data operation on the specific memory bank.

5. The integrated circuit of claim 4 wherein the second data bus that was not allowed to perform a second data operation on the specific memory bank is stalled.

6. The integrated circuit of claim 1 further comprising:
a first memory slave coupled to the first data bus and the memory controller; and
a second memory slave coupled to the second data bus and the memory controller.

7. The integrated circuit of claim 6 further comprising:
a third data bus coupled to the memory controller;
a fourth data bus coupled to the memory controller;
a third memory slave coupled to the memory controller;
a fourth memory slave coupled to the memory controller;
a third memory bank coupled to the memory controller;
a fourth memory bank coupled to the memory controller; and
wherein the first memory bank, the second memory bank, the third memory bank, and the fourth memory bank are interleaved such that consecutive memory addresses reside on different memory banks.

8. The integrated circuit of claim 7 further comprising:
a flash memory controller coupled to the first data bus, the second data bus, and the third data bus; and
a dynamic random access memory (DRAM) controller coupled to the first data bus, the second data bus, the third data bus, and the fourth data bus.

9. The integrated circuit of claim 8 wherein the flash memory controller further comprises a state machine to determine control of at least one output pin of the integrated circuit, the at least one output pin is shared between the flash controller and the DRAM controller.

10. The integrated circuit of claim 9, further comprising:
a multiplexer having a first input coupled to the flash memory controller and a second input coupled to the DRAM controller, the multiplexer having an output coupled to the at least one output pin of the integrated circuit;
wherein the multiplexer dynamically selects either the flash memory controller or the DRAM controller to control the multiplexer output.

11. The integrated circuit of claim 7 wherein the logic allows any one of the first data bus, the second data bus, the third data bus, and the fourth data bus to interface with any one of the first memory bank, the second memory bank, the third memory bank, and the fourth memory bank.

12. The integrated circuit of claim 11 wherein the first memory bank, the second memory bank, the third memory bank, and the fourth memory bank include on-chip random access memory (RAM).

13. The integrated circuit of claim 12 wherein the first data bus, the second data bus, the third data bus, and the fourth data bus comprise a multi-layer advanced high-speed bus (AHB) that allows parallel access paths between the AHB bus and the first memory slave, the second memory slave, the third memory slave, and the fourth memory slave.

14. The integrated circuit of claim 12 wherein the memory controller is a static random access memory (SRAM) controller.

15. The integrated circuit of claim 14 wherein the first memory bank, the second memory bank, the third memory bank, and the fourth memory bank include SRAM.

16. A method comprising:
receiving data at one of multiple slave devices in an integrated circuit, the data being received from at least one bus in a multiple layer bus;
providing the data to a memory controller;
selecting one of multiple memory banks as a selected memory bank to store the data, wherein the memory banks are interleaved such that a first memory address resides on a first memory bank and a next memory address resides on a second memory bank; and
storing the data in the selected memory bank.

17. The method of claim 16 further comprising performing simultaneous data operations on the multiple memory banks when a first bus performs a first data operation on a first memory bank and a second bus performs a second data operation on a second memory bank.

18. The method of claim 16 further comprising performing a round robin scheme when multiple busses attempt to perform data operations on one memory bank.

19. The method of claim 18 further comprising performing point arbitration to grant control of a specific memory bank to a first data bus for a first data operation.

20. The method of claim 19 further comprising stalling a second data bus from performing a second data operation on the specific memory bank while the first data bus is performing the first data operation.

21. The method of claim 16 further comprising performing a round robin calculation to determine an order of operations.

22. The method of claim 21 further comprising:
receiving, at the memory controller, an address from one of the slave devices;
decoding selected bits from the address to generate decoded bits;
calculating the order of operations based on the decoded bits; and
performing a first operation based on the order of operations.

23. A device comprising:
a memory controller;
a first data bus of a multi-layer data bus coupled to the memory controller;
a second data bus of the multi-layer data bus coupled to the memory controller;
a first memory slave coupled to the first data bus and the memory controller;
a second memory slave coupled to the second data bus and the memory controller;
a first memory bank coupled to a first data output of the memory controller;
a second memory bank coupled to a second data output of the memory controller; and
wherein the first memory bank and the second memory bank are interleaved.

24. The device of claim 23 wherein a first data memory address resides on the first memory bank and a data address consecutively after the first data address resides on the second memory bank.

25. The device of claim 23 wherein the memory controller further comprises logic to determine which memory bank to perform a requested data operation on.

26. The device of claim 25 wherein the logic further comprises logic to allow simultaneous data operations from different busses to be performed on different memory banks.

27. The device of claim 25 wherein the logic further comprises logic to perform a round robin calculation to determine which memory bank to write data to.
